(19) United States
(12) Patent Application Publication
(10) Pub. No.: US 2009/0268935 A1
(43) Pub. Date: Oct. 29, 2009

(54) HEADSET DEVICE

(75) Inventor: David A. Dillinger, Fort Mill, SC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: OUTSIDE THE BOX, INC., Pineville, NC (US)

(21) Appl. No.: 12/111,685

(22) Filed: Apr. 29, 2008

(51) Int. Cl. H04R 25/00

(52) U.S. Cl. 381/371

(57) ABSTRACT

A headset device comprising first and second headphones interconnected through a headband, wherein each of the first and second headphones comprises an earcup defining a unitary acoustic resonance chamber, a foraminous driver mount positioned offset from both a lateral axis and a longitudinal axis defined by the earcup, and a diaphragm retention ring extending from a surface of the foraminous driver mount. Each of the headphones further comprises a driver mounted within the driver mount and including a diaphragm, a foraminous unitary diaphragm support for maintaining the driver within the driver mount, an earcup cover attached to the earcup, and an earpad attached to the earcup.

### TECHNICAL FIELD AND BACKGROUND OF THE INVENTION

1. Field of the Invention

The present invention relates to a headset for use with an electronic device, which includes a unitary acoustic resonance chamber, offset driver mount, diaphragm retention ring and diaphragm support, among other features.

2. Description of the Related Art

Headsets are commonly used with portable and fixed devices to improve the listening experience, reduce ambient noise and relieve a user from having to handle the attached device. Exemplary types of electronic devices that benefit from the use of a headset include wireless communication devices, stereos, radios, media playing devices and PDAs, among other devices. The term “headphones” is typically used when describing a pair of loudspeakers maintained close to a user's ears, examples of which include circumaural, supra-aural, earbud and in-ear headphones. The term “headset” is typically used when describing headphones that also include a microphone for inputting speech. The term “headset” is used generically herein to refer to both headphones with an attachable microphone, and those without.

Conventional headphones typically include a baffle for supporting a driver. The baffle is mounted to some form of headphone cup that also attaches to a cushion that positions around the ear. Headphones that include a baffle often suffer from resonance within headphone cup. These conventional headphones also require a cavity positioned behind the baffle away from the ear, thus requiring a more complicated construction and volume within the headphone.

Accordingly, what is desired is a headset device having an improved earcup design that eliminates or substantially reduces undesirable resonance. Further, what is desired is a headphone that includes an earcup that functions not only as a unitary resonance chamber, but is also adapted to support the driver, thus obviating the need for a separate baffle. A desirable headset device would provide improved produced sound, be comfortable to wear, have a simplified construction, and be compatible with any electronic equipment capable of working in cooperation with a headset.

### SUMMARY OF THE INVENTION

Therefore, it is an object of the invention to provide a headset for use with electronic devices.

It is another object of the invention to provide a circumaural headset device including circular- or ellipsoidal-shaped earpads that fit over and around the ears.

It is yet another object of the invention to provide a headset device including an ear cup design that functions to isolate the ear from ambient sounds.

It is yet another object of the invention to provide a headset device including a unitary acoustic resonance chamber and offset driver position that function to deliver improved produced sound.

It is yet another object of the invention to provide a headset device having an ear cup cover pivotally attached to the ear cup to facilitate battery compartment access.

It is yet another object of the invention to provide a headset device including a unitary acoustic resonance chamber, offset driver mount having a diaphragm retention ring, and a foraminous driver support that function together to provide improved produced sound.

It is yet another object of the invention to provide a headset device including a jack for receiving a connector of a detachable boom microphone.

It is yet another object of the invention to provide a headset device including a pair of headphones physically and operationally interconnected through a strap, headband or other means.

These and other objects of the present invention are achieved in the preferred embodiment disclosed below by providing a headset device including an ear cup defining a unitary acoustic resonance chamber, a foraminous offset driver mount defining a diaphragm retention ring, a foraminous unitary diaphragm support, and an ear cup cover capable of being selectively pivoted between opened and closed positions to access a battery compartment.

According to one embodiment of the invention, the ear cup defines a unitary acoustic resonance chamber having a first side to which a cushioning earpad attaches, and a second side to which an ear cup cover attaches. The ear cup cover may be pivotally attached to the headphone that includes a battery compartment defined within the ear cup. The ear cup defines a driver mount that is offset from both the longitudinal and lateral axes defined by the ear cup to better position the driver about the ear canal. The driver mount is foraminous and defines a raised diaphragm retention ring for maintaining the diaphragm. In one embodiment, the retention ring aligns with the voice coil of the driver. The driver, which may be any conventional driver, is supported and maintained within the driver mount by a foraminous, disc-shaped support.

At least one of the ear cups of the headset defines a jack for receiving a detachable microphone. While a first ear cup of the headset device defines a battery compartment for receiving at least one battery therein, the second ear cup of the headset defines a support surface for mounting a buffer board thereon. In one embodiment, the buffer board defines a cut-out portion to provide a clearance about the magnet of the driver. The buffer board supports the electronic components and conductive pathways of the headset device. In ambient noise reducing devices, the buffer board may further support an ambient noise receiving microphone. The ear cup cover of the second ear cup is preferably securely fastened to the ear cup and does not pivot.

The headset device further includes a headband, which may or may not be adjustable, for physically and operationally connecting the first and second headphones. At least one of the headphones includes a wired or wireless connection for connecting with the electronic device. An example of a wired connection includes a conventional TRS connector well known in the art. An example of a wireless connection includes BlueTooth®.

Additional features and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

FIG. 1 is a perspective view of a headset device according to a preferred embodiment of the present invention;

FIGS. 2A and 2B are isolated front and rear perspective views, respectively, of the first ear cup of the headset device;

FIGS. 3A and 3B are isolated front and rear perspective views, respectively, of the second ear cup of the headset device;

FIG. 4 is an isolated perspective view of the buffer board for mounting to the second ear cup;

FIG. 5 is a perspective view of the foraminous driver support;

FIG. 6 is a top view of the first headphone shown with the pivotally attached ear cup cover shown in the opened configuration; and

FIGS. 7A and 7B are top and bottom views, respectively, of a driver for use with the present invention.

### DETAILED DESCRIPTION OF THE INVENTION

Embodiments of the present invention will be described below with reference to the drawings and the reference numerals. However, the present invention is not limited to the embodiments described below. In the present invention, it is intended that the term “headset” means a pair of interconnected headphones that may or may not include a detachable microphone, and also capable of broadcasting in at least one of stereo and monophonic sound. That is, the headset may be capable of broadcasting in stereophonic sound when the microphone is detached, and monophonic sound when the microphone is attached. The headphones may be attached by a strap, headband or any other attachment means that may or may not be adjustable. In addition to the features described below, the headset device may include other conventional features including, but not limited to, volume control, power on/off and indicator lights.

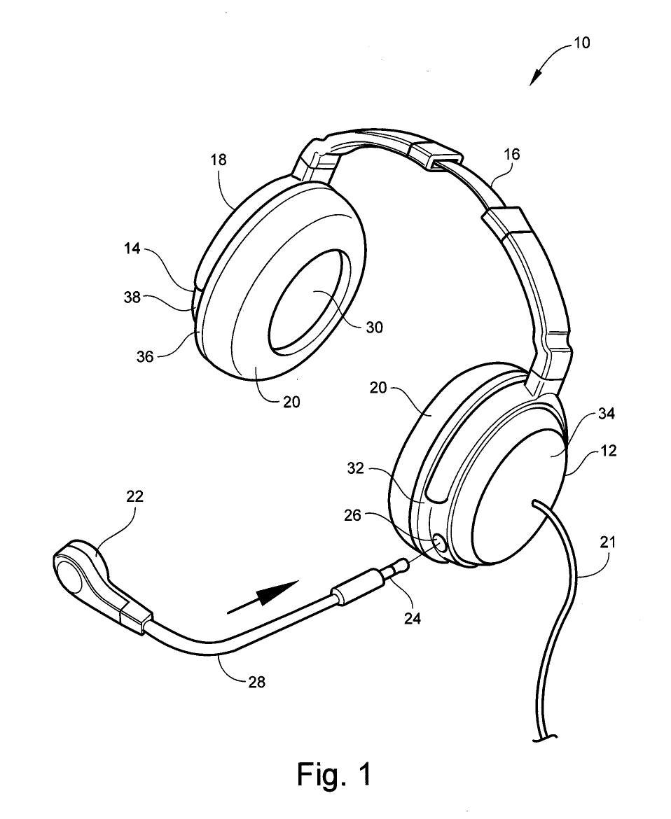

As shown in FIG. 1, a headset device 10 in accordance with the present invention includes a first headphone 12 and a second headphone 14 that are interconnected through an adjustable headband 16. The headband 16 connects to the first and second headphones through a bracket 18 that allows the headphones to pivot relative to the bracket for maximum adjustability to the wearer. As shown, the headset device 10 is of the circumaural-type and includes circular- or ellipsoidal-shaped earpads 20 that fit over and around the ears of the user. While a circumaural-type headset device is shown, principles of the present invention may be applied to other headphone types as well including, but not limited to, supra-aural, earbud and in-ear headphones, all of which provide varying levels of sound isolation. The headset device 10 includes a means for electronically connecting the device to a portable or fixed electronic device. As shown, the headset device 10 includes a wired connection, such as a conventional, standard TRS connector (not shown) terminating the wire 21. The connection may also be wireless, such as through BlueTooth®) technology. The wired or wireless connection may be provided through either of the first and second headphones 12 and 14.

A detachable microphone 22 including a conventional, standard TRS connector 24 is shown detached from the headset device. The connector 24 is received within jack 26 which includes internal structure for engaging the connector 24 and operationally connecting the microphone 22 to the headset device 10 as is known in the art. While a boom microphone is shown having a flexible boom 28 for positioning the microphone 22 about the user's mouth, any type of conventional microphone may be used with the headset device of the present invention. The first and second headphones 12 and 14, headband 16 and microphone 22 are preferably constructed of molded plastics or other durable, lightweight materials. The earpads 20 are preferably vinyl covered, resilient foam or other equivalent materials commonly used for headphone earpads. The configuration of the headphones to the headband, and the earpads are not specifically limited. Produced sound is projected through at least opening 30 defined by the earpad 20.

The first headphone 12 includes a first earcup 32 positioned between the earpad 20 and a first earcup cover 34. The second headphone 14 includes a second earcup 36 positioned between the earpad 20 and a second earcup cover 38. The earcups 32 and 36 are discussed in detail in below.

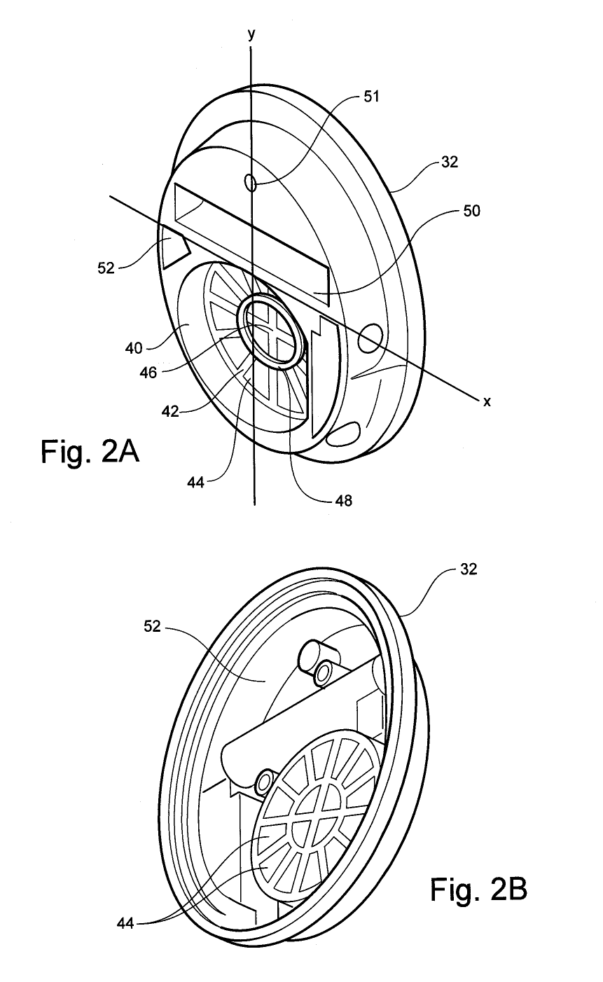

FIGS. 2A and 2B are front and rear perspective views, respectively, of the first earcup 32 of the first headphone 12 in accordance with the present invention. In FIGS. 2A and 2B, the earcup 32 is shown removed and isolated from the rest of the headset device components in order to simply show the earcup structure. As shown, the earcup 32 defines a driver mount 40 for seating and maintaining a driver therein. The driver mount surface 42 adjacent the driver diaphragm defines a plurality of openings 44 for broadcasting the produced sound therethrough. As shown, the driver mount is circular-shaped and includes openings arranged radially about a center 46. In the embodiment shown, the openings 44 are arranged about the entire surface 42. In an alternative embodiment, the openings may be fewer and cover a smaller portion of the surface 42, such as about one-half of the surface. A diaphragm retention ring 48 extends from the surface 42 and retains the diaphragm of the driver, thus preventing over-extension of the diaphragm. The diaphragm retention ring 48 preferably aligns with the voice coil of the driver. The driver mount 40 is preferably aligned offset with respect to both the longitudinal y and lateral axes x of the ear cup. One advantage of the offset driver mount includes improved alignment with the ear canal. The first earcup 32 further defines a battery compartment 50 for receiving at least one device powering battery therein. The earcup 32 further defines a hole 51 for receiving a fastener of the earcup cover, such as a screw or like fastener that attaches the cover while allowing the earcup cover to pivot relative to the earcup 32 to access the battery compartment 50.

The earcup 32 structure defines a unitary acoustic resonance chamber 52 including a plurality of smaller chambers defined by the earcup 32 that are interconnected through a plurality of openings between chambers. The earcup 32 is thus “open” and allows the sound waves produced by the driver to propogate freely throughout the earcup. The foraminous resonance chamber reduces distortion due to the lack of earcup resonances. Sound from the outside is preferably attenuated by the earcup cover, however, the earcup cover may include venting for allowing sound waves to exit and reduce distorting sound in certain frequencies due to resonance within the earcup 32.

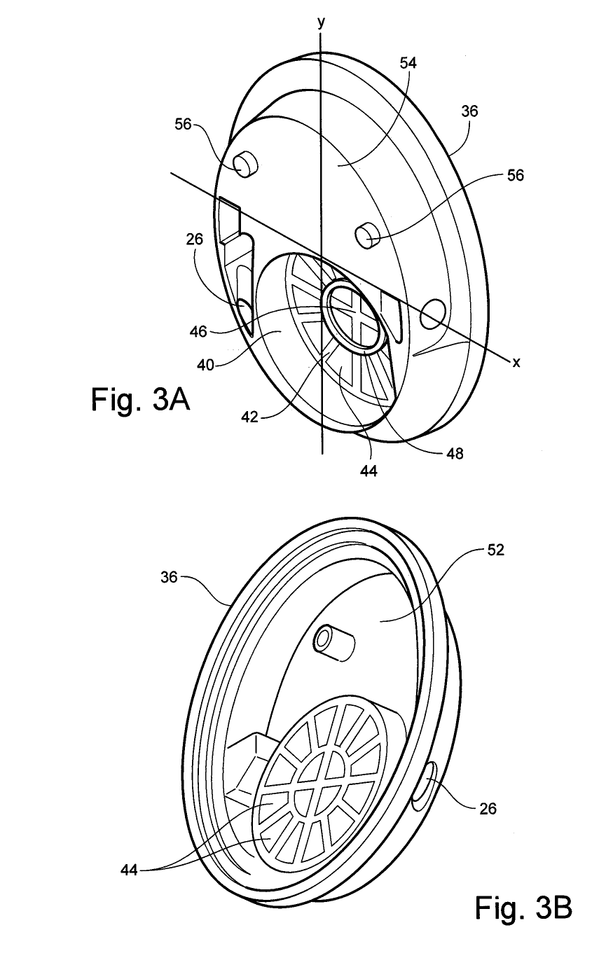

FIGS. 3A and 3B are front and rear perspective views, respectively, of the second earcup 36 of the second headphone 14 in accordance with the present invention. In FIGS. 3A and 3B, the second earcup 36 is shown removed and isolated from the rest of the headset device components in order to simply show the earcup structure. As shown, the earcup 36 defines a driver mount 40 for seating and maintaining a driver therein. The driver mount surface 42 adjacent the driver diaphragm defines a plurality of openings 44 for broadcasting the produced sound therethrough. As shown, the driver mount is circular-shaped and includes openings arranged radially about a center 46. In the embodiment shown, the openings 44 are arranged about the entire surface 42. In an alternative embodiment, the openings may be fewer and cover a smaller portion of the surface 42, such as about one-half of the surface. A diaphragm retention ring 48 extends from the surface 42 and retains the diaphragm of the driver, thus preventing over-extension of the diaphragm. The diaphragm retention ring 48 preferably aligns with the voice coil of the driver. The driver mount 40 is preferably aligned offset with respect to the longitudinal y and lateral axes x of the ear cup.

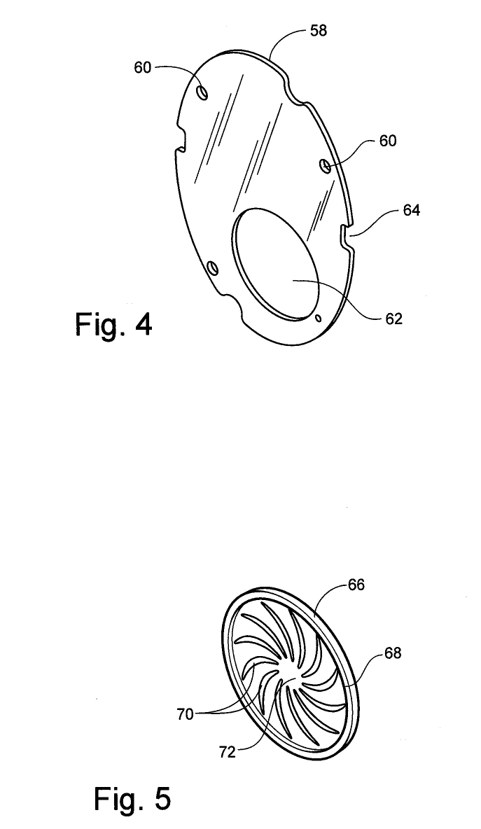

The second earcup 36 further defines a mounting surface 54 for mounting a buffer board thereon. A plurality of mounting posts 56 extend from the mounting surface 54 and are received within openings defined by the buffer board shown in FIG. 4. The second earcup 36 further defines an opening 26 for accessing the jack for the detachable microphone. The second earcup structure also defines a unitary acoustic resonance chamber 52 including a plurality of smaller chambers that are interconnected through a plurality of openings between chambers. The earcup 36 is thus “open” and allows the sound waves produced by the driver to propogate freely throughout the earcup. The earcup cover 38 for the second earcup 36 may or may not include venting for allowing sound waves to exit and reduce distorting sound in certain frequencies due to resonance within the earcup 36.

FIG. 4 is a perspective view of a buffer board 58 for supporting the electronic components and conductive pathways of the headset device 10. The buffer board defines a plurality of openings 60 for receiving the mouting posts 56 of the mounting surface 54. The buffer board is preferably maintained elevated from the support surface 54. In the embodiment shown, the buffer board defines a circular-shaped, cut-out portion 62 to provide a clearance about the magnet of the driver and a means for accessing the driver without having to remove the buffer board. In an alternative embodiment, the buffer board may define a C-shaped cut-out about the driver. The buffer board 58 further defines a plurality of clearances 64 around its perimeter for clearing fasteners of the second earcup cover 38. In ambient noise reducing headset devices, the buffer board may further support an ambient noise receiving microphone and associated components.

FIG. 5 is a perspective view of a foraminous driver support 66. The driver support 66 defines a lip 68 around a center portion defining a plurality of openings 70 arranged in a fan-like arrangement. The center portion 72 contacts the magnet housing of the driver. The driver support 66 maintains the driver within the driver mount 40, and the backside of the driver support preferably aligns flush with the surface of the earcup. An identical, disc-shaped driver support may be used for both the first and the second earcups 32 and 36. The foraminous construction of the driver support 66 contributes to the overall foraminous construction of the earcup.

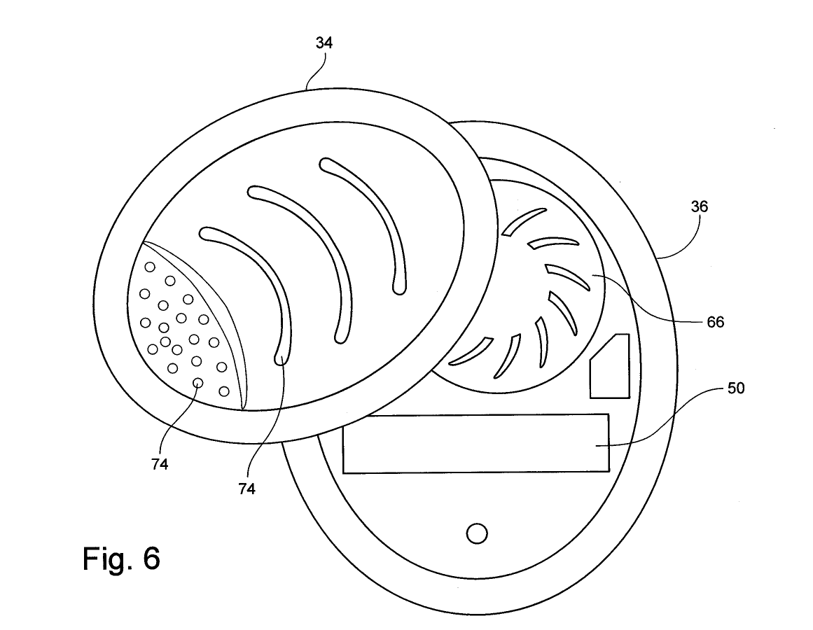

FIG. 6 is a top view of the first earcup 32 shown partially assembled and with the earcup cover 34 pivotally attached. The headphone is shown in the “opened” configuration. The earcup 32 includes the defined battery compartment 50 and installed driver support 66. The earcup cover 34 is pivotally attached in order to allow access to the battery compartment while maintaining the earcup cover 34 with the earcup 32, so that the earcup cover 34 is not separated from the headset device 10. The earcup cover 34 may optionally defining venting 74 for removing heat and allowing sound waves to exit. The earcup cover 34 is preferably made from molded plastic.

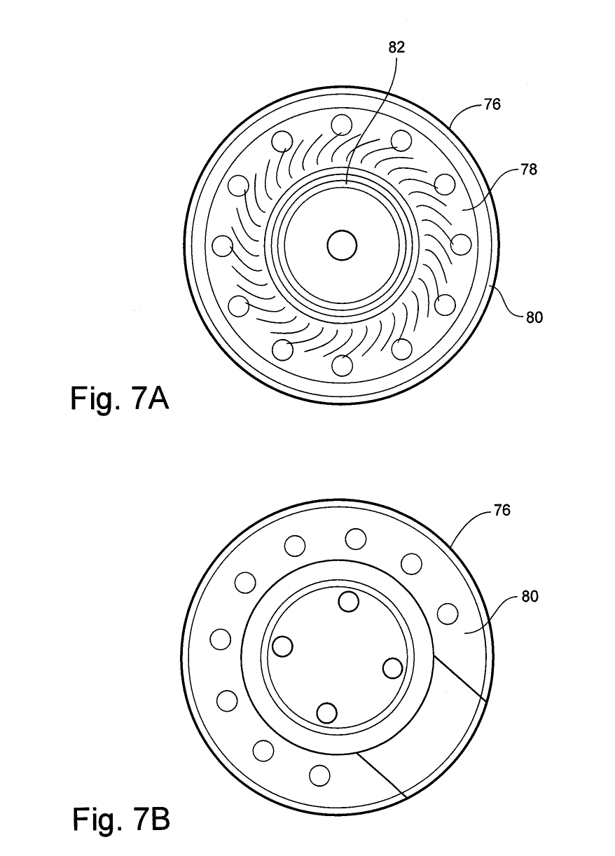

FIGS. 7A and 7B are top and bottom views, respectively, of a conventional driver for use with the headset device 10 of the present invention. The driver includes a lightweight diaphragm 78 connected to a rigid frame 80. The diaphragm 78 is flexible and allows a coil of fine wire to move axially through a cylindrical magnetic gap. The diaphragm may be manufacturd in any low-profile shape, and is preferably made from plastic. The frame 80 is preferably made from cast or stamped metal or plastic, which has rigidity to avoid deformation, thus preventing the voice coil from rubbing against the magnet structure. The voice coil 82 and wire are preferably made of copper.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A headphone, comprising:
an earcup defining a unitary acoustic resonance chamber, a foraminous driver mount positioned offset from both a lateral axis and a longitudinal axis defined by the earcup, and a diaphragm retention ring extending from a surface of the foraminous driver mount;
a driver mounted within the driver mount and including a diaphragm;
a foraminous unitary diaphragm support for maintaining the driver within the driver mount;
an earcup cover associated with the earcup; and
an earpad associated with the earcup.

2. The headphone according to claim 1, wherein the earcup further defines a battery compartment for receiving at least one battery therein.

3. The headphone according to claim 1, further comprising a buffer board for supporting electronic components and conductive pathways, and wherein the earcup defines a mounting surface for mounting the buffer board thereon, the mounting surface defining a plurality of mounting posts extending from the mounting surface for being received within mounting holes of the buffer board.

4. The headphone according to claim 1, wherein the earcup cover is pivotally attached to the earcup.

5. The headphone according to claim 1, further comprising a jack for receiving a connector of a detachable microphone.

6. The headphone according to claim 1, wherein the unitary acoustic resonance chamber comprises a plurality of smaller chambers interconnected through a plurality of openings defined through walls of the earcup.

7. The headphone according to claim 1, wherein the foraminous unitary diaphragm support is disc-shaped and defines a plurality of openings arranged in a fan-shape radially about a center of the unitary diaphragm support.

8. The headphone according to claim 1, further comprising one of a wired and a wireless connection for operationally connecting the headphone to an electronic device.

9. A headset device, comprising:
a first headphone and a second headphone, each including:
an earcup defining a unitary acoustic resonance chamber, a foraminous driver mount positioned offset from both a lateral axis and a longitudinal axis defined by the earcup, and a diaphragm retention ring extending from a surface of the foraminous driver mount;
a driver mounted within the driver mount and including a diaphragm;
a foraminous unitary diaphragm support for maintaining the driver within the driver mount;
an earcup cover associated with the earcup; and
an earpad associated with the earcup;
a headband for interconnecting the first and second headphones.

10. The headset device according to claim 9, wherein the earcup further defines a battery compartment for receiving at least one battery therein.

11. The headset device according to claim 9, further comprising a buffer board for supporting electronic components and conductive pathways, and wherein the earcup defines a mounting surface for mounting the buffer board thereon, the mounting surface defining a plurality of mounting posts extending from the mounting surface for being received within mounting holes of the buffer board.

12. The headset device according to claim 9, wherein the earcup cover is pivotally attached to the earcup.

13. The headset device according to claim 9, further comprising a jack for receiving a connector of a detachable microphone.

14. The headset device according to claim 9, wherein the unitary acoustic resonance chamber comprises a plurality of chambers interconnected through a plurality of openings defined through walls of the earcup.

15. The headset device according to claim 9, wherein the foraminous unitary diaphragm support is disc-shaped and defines a plurality of openings arranged in a fan-shape radially about a center of the unitary diaphragm support.

16. The headset device according to claim 9, further comprising one of a wired and a wireless connection for operationally connecting the headphone to an electronic device.

17. A headset device, comprising:
an earcup defining a unitary acoustic resonance chamber comprising a plurality of smaller chambers interconnected through a plurality of openings defined within walls of the earcup;
a driver mount defined by the earcup and positioned offset with respect to a longitudinal axis and a lateral axis defined by the ear cup, the driver mount defining a surface and a plurality of openings defined within the surface;
a diaphragm retention ring extending from the surface of the driver mount; and
a foraminous unitary diaphragm support for supporting a driver within the driver mount.

18. The headset device according to claim 17, further comprising a buffer board mounting surface defined by the ear cup for mounting a buffer board thereon.

19. The headset device according to claim 17, further comprising a battery compartment defined by the earcup for receiving at least one battery therein.

20. The headset device according to claim 17, further comprising an earcup cover pivotally attached to the earcup.
